(19) United States
(12) Patent Application Publication
(10) Pub. No.: US 2017/0237698 A1
(43) Pub. Date: Aug. 17, 2017

(54) Method For Scheduled Delivery of Social Media Messaging

(71) Applicant: Adam Besnard, Tampa, FL (US)

(72) Inventor: Adam Besnard, Tampa, FL (US)

(21) Appl. No.: 15/418,800

(22) Filed: Jan. 30, 2017

Related U.S. Application Data
(63) Continuation of application No. 62/294,426, filed on Feb. 12, 2016.

(51) Int. Cl. H04L 12/58; G06F 17/30; H04L 29/08

(52) U.S. Cl. CPC H04L 51/18; H04L 51/32; H04L 67/306; H04L 67/325; G06F 17/30867; G06F 17/30876

(57) ABSTRACT

A system and method for delaying messages posted to Social Media Websites based on a set or predetermined time period by the Social Media User whereby the Social Media User creates a message, determines when the message should be posted and whether that time should be randomized to within a preset time window, sends the message to a central server for storage, and has the central server post the message to the Social Media Website at the predetermined time.

### RELATED APPLICATION DATA

This application claims priority to U.S. Provisional Patent Application Ser. No. 62/294,426, filed Feb. 12, 2016, entitled “Method for Scheduled Delivery of Social Media Messaging,” the contents of which are fully incorporated by reference herein for all purposes.

### BACKGROUND OF THE INVENTION

Field of the Invention

This invention relates to a system and method for providing users (“Social Media Users”) who use online social media services (“Social Media Websites”) with a means of scheduling updates and communication with other Social Media Users at predetermined times. More specifically, the invention relates to delaying the posting of social media updates outside of a given time frame. The delaying could be during certain timeframes (for example, Work or School Hours). Further, when the time is reached in which queued posts can be sent, they could then have options to post all immediately OR with a random variability as to the time of posting to avoid regularity—For example, 1 post every 1 minute to 2 minutes. So let's say the person gets off work at 4:30 so they have set delay to always occur Monday to Friday until 4:45. Starting at 4:45 pm, posts would start occurring in a way which appears random and not to be scheduled.

Background of the Invention

Social media dominates the Internet in the modern era. Services such as Facebook, Instagram, Twitter, Tinder, Bumble, Pinterest, LinkedIn, Google+, YouTube, Snapchat and a host of other social media providers allow countless people to share, link, like, and otherwise connect with other people in the world. With so many online services providing updates, it is getting harder and harder to avoid the temptation of keeping up with it during times when one is really supposed to be doing something else like working. Many workplaces frown upon checking social media during the workday and some consider it a fire-able offense. Schools use the same rationale. Thus, Social Media Users in the past would either have to wait until they got off of work or school to check Social Media Websites and create posts of their own or risk getting reprimanded or fired. There are presently no solutions to this problem. Therefore, there exists a need for a system and method for the scheduled delivery of social media messaging at a predetermined time period.

### SUMMARY OF THE INVENTION

For purposes of summarizing this invention, the present invention is directed to a method for delaying messages posted to Social Media Websites based on a set or predetermined time period by the Social Media User whereby the Social Media User creates a message, determines when the message should be posted and whether that time should be randomized to within a ten minute window, sends the message to a central database for storage, and has a central server access the post in the central database and post the message to the Social Media Website at the predetermined time.

It is, therefore, a principle object of this invention to provide a system and method for allowing a Social Media User to post during the work/school day and delay the time of actual posting so as to mask Social Media Website use during the day.

It is another object of this invention to provide a system and method for allowing scheduled delivery of a social media posting.

It is another object of this invention to provide a system and method for storage of messages for a variety of Social Media Websites in a central location prior to posting.

It is another object of this invention to provide a randomization capability so as to mask the time of messaging and prevent establishing a pattern by posting at a particular time period.

In accordance with these and other objects, the invention is directed towards a system and method for the scheduled delivery of social media messaging that has never been achieved heretofore.

The system and method disclosed herein results in a product which is completely unexpected and dramatically superior to what conventional wisdom in the field would predict.

### BRIEF DESCRIPTION OF THE DRAWINGS

For a fuller understanding of the nature and objects of the invention, reference should be had to the following detailed description taken in connection with the accompanying drawings in which:

FIG. 1 is a view of the overall system and method.

FIG. 2 is a view of the steps performed by the system and method.

FIG. 3 is a view of a social media content database in accordance with an embodiment of the present disclosure.

Similar reference characters refer to similar parts throughout the several views of the drawings.

### DETAILED DESCRIPTION OF THE PREFERRED EMBODIMENT

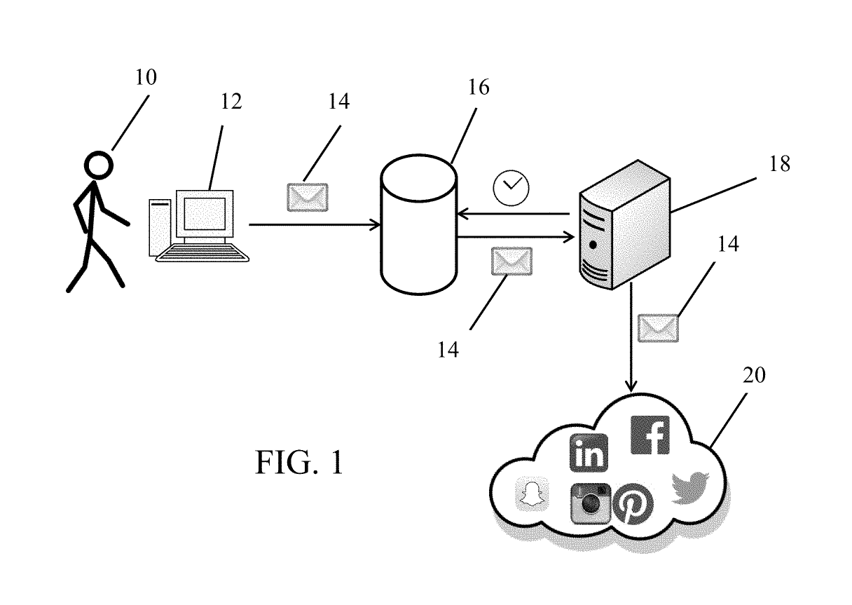

FIG. 1 shows a visualization of the system and method. In it, a Social Media User 10 uses a local computing device 12 to craft a social media message 14. The local computing device 12 can be any number of devices including a personal computer, laptop, cell phone, tablet, or any other networked electronic device. Once complete, the Social Media User 10 sets the schedule for the social media message 14 and decides whether the posting time should be randomized. In one embodiment, randomization may be done to a time period within 3-10 minutes of the scheduled posting time. The Social Media User 10 then submits the message 14 to the system. The social media message 14 is then sent to a central social media content database 16 for storage until the preset time. The social media content database 16 is in contact with a central server 18 via a processor.

The social media message 14 is stored in the social media content database 16 in connection with a number of pieces of information. In a preferred embodiment, the data that is stored in the social media content database 16 comprises the social media posting, a user account, a social media network, a posting time, and a randomization selector. A social media posting may be any posting that would typically go on a social network, such as a tweet, a Facebook post, a LinkedIn post, or the like.

The social media content database 16 may be on a centralized server, or may alternatively be stored on the local computing device 12 the Social Media User 10 carries. In this alternative embodiment, there may be one or more social media content databases 16, for example a local social media content database 16 stored on the local computing device 12 enabling the Social Media User 10 to post social media content while the local computing device 12 is not connected to any network. For example, the Social Media User 10 may be in an area of no network connection (a convention center, an airplane, or otherwise) and still be able to deliver social media messaging in accordance with the present disclosure. In such an embodiment, the social media posting is stored in the local social media content database. When the local computing device 12 regains a network connection interconnecting it with the central social media content database 16, the system may deliver the locally stored social media postings to the central social media content database 16 so that the social media messages may be delivered in accordance with the present disclosure.

The user account information is preferably information about the user of the present system. The social media network may be one or more than one social media networks on which the social media posting should be posted at the desired time. The posting time is a desired time at which the user wishes the social media posting to be posted. The randomization selector is preferably a selector as to whether or not the user wants the timing of the post to be randomized. In one instance, where the randomization selector is disabled, the social media post will be posted at or around the desired posting time (i.e. the posting time stored in the social media content database 16). In another instance, the randomization selector is enabled and the system may determine a random interval to change the posting time. In another instance, the randomization selector may be a number which can indicate a desired number of seconds or minutes (or other time interval) to delay or alter the posting time of the social media posting.

The system also preferably stores a social media accounts database. In a preferred embodiment, the social media accounts database may be stored in the central server 18. The social media accounts database preferably includes a mapping of user accounts to one or more social media accounts the user is associate with. For instance, the Social Media User 10 may have accounts with Facebook, Twitter, and Linkedin. This mapping would preferably be stored in the social media accounts database.

The processor periodically polls the social media content database 16 at predetermined time intervals. These time intervals can be any predetermined time interval. In a preferred embodiment, the processor polls the social media content database 16 every minute. When polling the social media content database 16 the processor selects information from the social media content database 16, preferably using standard database selection mechanisms. For example, in a preferred embodiment, the social media content database 16 is a relational database and the processor executes Simple Query Language (“SQL”) commands on the social media content database 16.

In a preferred embodiment, the processor initially looks for data having the randomization selector enabled. Thus, this initial look will gather all social media entries that are intended to be posted within a particular time range, but with their post scheduling randomized. In a preferred embodiment to implement the randomization, the processor may then update the posting time field associated with the social media posting item, and disable the randomization switch so that the social media item will be gathered and posted in a later iteration of the polling of the social media content database, discussed below.

The processor next looks for data having the randomization selector enabled and falling within a particular time range. This polling will gather all social media entries that are intended to be posted within a particular time range, but without randomization. Thus, prior randomized entries will have already been stored in the database and ready to be published at their now-randomized time.

The processor then posts the message 14 to the associated Social Media Website 20. Initially, when the Social Media User 10 sets the schedule for posting, the particular Social Media Website 20 may be chosen as well. At any point during the process prior to the actual posting, the Social Media User 10 may reenter the system through and cancel the scheduled posting. In a preferred embodiment, this will delete the entry from the social media content database 16.

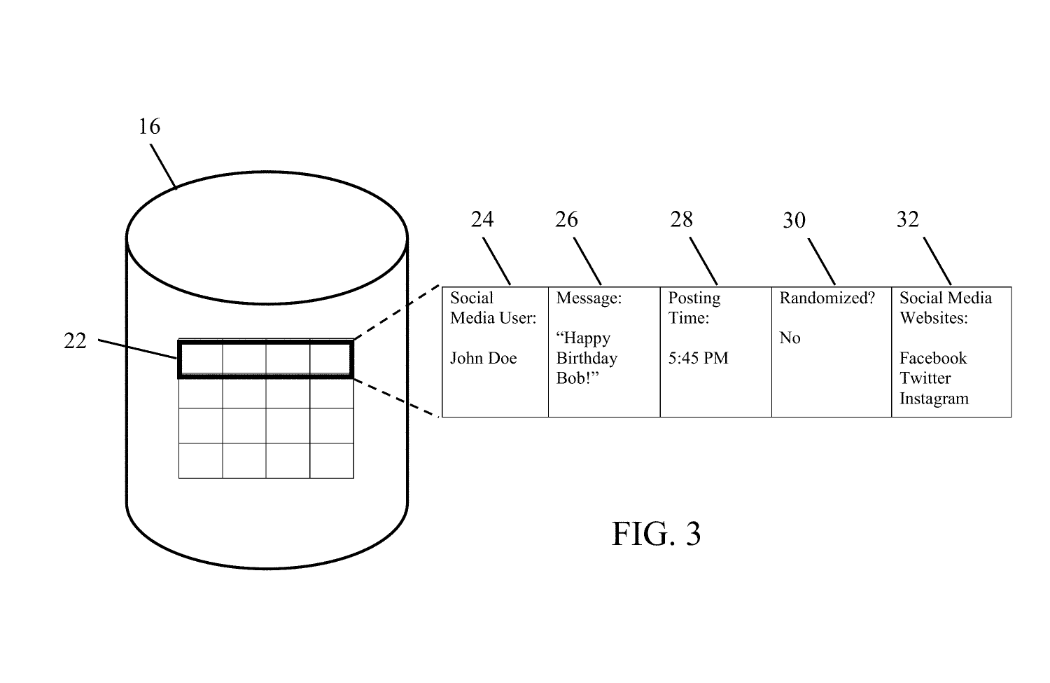

As an illustrative example, a Social Media User 10 may log in to the system and create a message 14 soon after entering the workplace or classroom. The Social Media User 10 would then set the schedule for posting; for example, the Social Media User 10 may want to have the message 14 post any time after 5:30 pm. The message 14 would be stored in the social media content database 16 until 5:30 pm. At that time, the central server 18 would contact the social media content database 16, locate the relevant message 14, and then post the message 14 on the previously determined Social Media Website 20. Further detail about the social media content database 16 can be found in FIG. 3. The posting could occur either exactly at 5:30 pm or could happen anytime between 5:30 pm and 5:40 pm if the Social Media User 10 chose to randomize when the posting occurred. The randomization option is meant to obscure use of the system by the Social Media User 10 from others such as superiors or teachers.

As another illustrative example, a Social Media User 10 may log in to the system and create a message 14 for delivery days, weeks, or months later. For instance, the Social Media User 10 may remember that her mother's birthday is in four weeks, and create a message to deliver to her mother four weeks later at a particular time. The message 14 will be stored in the social media content database 16 until four weeks later when the system retrieves the message 14 and posts it as described above. And if the Social Media User 10 wishes to change the message 14 before it is delivered, she may update the message 14 in the social media content database 16 prior to its distribution.

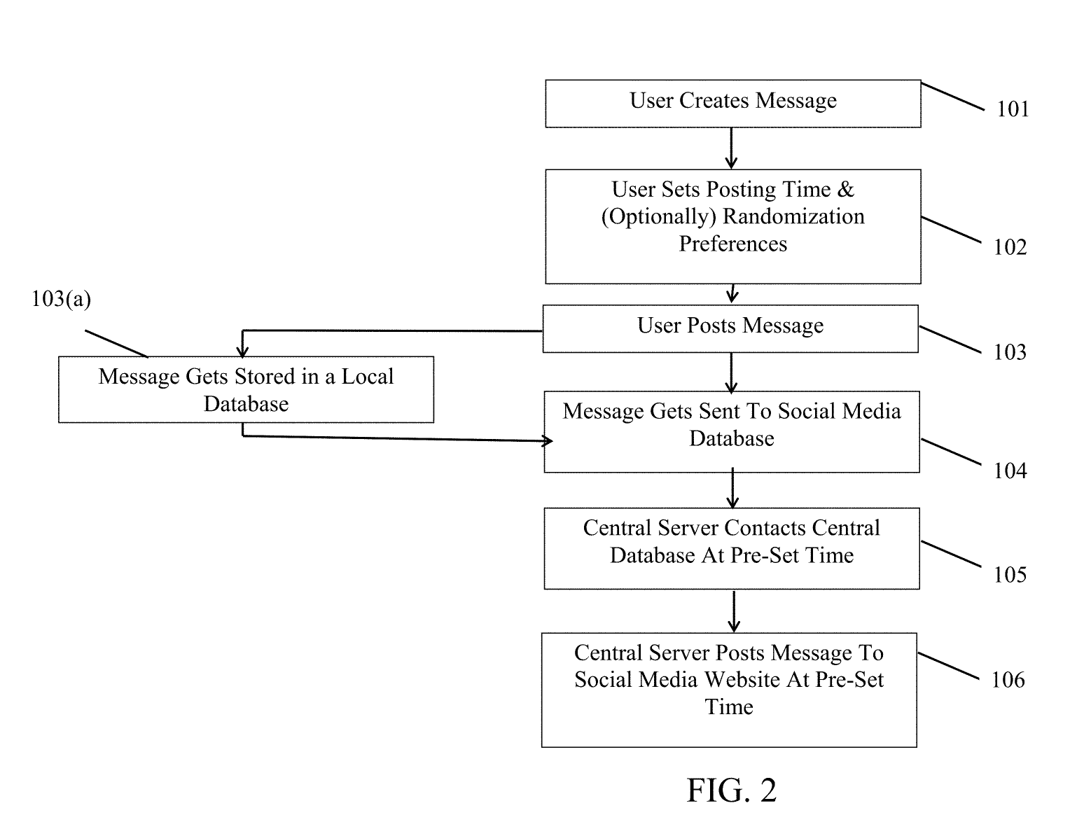

FIG. 2 shows a flow diagram of the system and method. In step 101, the Social Media User 10 creates the message 14 on a local computing device 12. In step 102, the Social Media User 10 then goes on to set the schedule and randomization preferences as well as the particular Social Media Websites 20 where the Social Media User 10 desires to post the message 14. In step 103, after selecting the schedule and randomization preferences, the Social Media User 10 posts the message 14. In one embodiment, by posting the message 14, the Social Media User 10 actually sends the message 14 to a central database 16 for storage until the predetermined time, as shown in step 104. In an alternative embodiment, for instance when the local computing device 12 is not connected to a network, by posting the message 14, the Social Media User 10 stores the message 14 in a local social media content database stored on the local computing device 12 as shown in optional step 103(a). In this embodiment, when the local computing device 12 regains a network connection, the local computing device 12 transmits the locally stored message 14 to the social media content database 16. Alternatively, a processor associated with the social media content database 16 may poll the local computing device 12 and retrieve messages stored in the local social media content database.

In steps 105 and 106, the central server 18, which is constantly in contact with the central database 16, contacts the central database 16 at the predetermined time, identifies the relevant message 14, and posts the message 14 to the predetermined Social Media Website 20 determined, as determined in step 102.

FIG. 3 shows the social media content database 16 and step 105/106 in more detail. Each entry 22 includes data such as the Social Media User entry 24, the message entry 26, the posting time entry 28, the randomization entry 30, and the social media website entry 32. When contacting the central database 16 at any given time, the central server 18 checks the posting time entry 28 and, when the posting time entry is in tolerance, grabs the message entry 26 and forwards the contents to the Social Media Websites 20 based on the social media website entry 32.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is Claimed is:

1. A method for scheduled posting of social media content, the method comprising:
receiving, at a central computer server, a scheduled social media message wherein a scheduled social media message comprises a social media posting, a user account, a social media network, a posting time, and a randomization selector;
storing the scheduled social media message in a scheduled social media post database;
polling the central computer server once every minute, wherein polling comprises selecting data from the scheduled social media post database wherein the data has a posting time within a time interval wherein the time interval is a time range of one minute before the current time to one minute after the current time, wherein the selected data comprises the social media posting, the user account, the social media network, the posting time, and the randomization selector;
for each data polled from the central computer server wherein the data has the randomization selector enabled, calculating a random number within a preset range and updating the social media message in the scheduled social media post database with an updated posting time and disabling the randomization selector;
for each data polled from the central computer server wherein the data has the randomization selector disabled, determining a social media account in which the data is intended to be posted on using the social media network, wherein determining comprises polling a social media accounts database wherein the social media accounts database comprises a mapping of at least one user account to at least one social media account;
for each determined social media account, posting the social media posting from the central computer server to the social media account using a programmatic computer interface of the social media network;
upon successful posting of the social media posting, deleting the social media message from the scheduled social media post database.

2. A method for scheduled posting of social media content, the method comprising:
storing social media content in a database, wherein the social media content comprises a social media post, a time, a randomizer switch, and a social media network;
at a preselected time, selecting all social media content from the database that satisfies a time-based selection criteria;
for each selected social media content wherein the social media content randomizer switch is enabled, generating a random number within a preset range and updating the selected social media content in the database with a new time using the random number;
for each selected social media content wherein the social media content randomizer switch is disabled, posting the social media post on the social media network; and
deleting the social media content from the database after the social media post has been posted on the social media network

3. The method of claim 2 further comprising;
storing the database in a central server.

4. The method of claim 2 further comprising;
storing in a second database a mapping of at least one user account to at least one social media account, wherein posting the social media post on the social media network comprises selecting a social media account from the second database.

5. The method of claim 2 further comprising;
wherein the time-based selection criteria is a time range.

6. The method of claim 5 further comprising;
wherein the time range is five minutes.

7. The method of claim 5 further comprising;
wherein the time range is computed based on the current time.

8. The method of claim 2 further comprising;
wherein the preselected time is every minute.

9. The method of claim 2 further comprising;
wherein the preselected time is every five minutes.

10. The method of claim 2 further comprising;
wherein the social media network is selected from the list comprising Facebook, Instagram, Twitter, Tinder, Bumble, Pinterest, LinkedIn, Google+, YouTube, and Snapchat.

11. A system for delayed posting of social media content comprising;
a social media content database, the social media content database comprising data storage for a plurality of social media message, wherein each social media message comprises a social media posting, a user account, a social media network, a posting time, and a randomization selector, the social media content database further comprising a network interface for connecting the social media content database to a first network;
a social media accounts database, the social media accounts database comprising data storage for a plurality of mappings of user accounts to social media accounts;
a communication interface for connecting the social media content database to the social media accounts database via a processor;
a central processor;
a central processor network communication interface for connecting the central processor to a second network;
wherein the central processor is configured to poll the social media content database at a first predetermined time intervals, wherein polling comprising selecting at least one social media message from the social media content database wherein the posting time associated with the social media message satisfies a time-based selection criteria and the randomizer switch associated with the social media message is enabled, the central processor further configured to generate a random number within a preset range, and further configured to update the social media message in the social media content database with an updated posting time using the random number;
wherein the central processor is further configured to poll the social media content database at a second predetermined time intervals, wherein polling comprises selecting at least one social media message from the social media content database wherein the posting time associated with the social media message satisfies a time-based selection criteria and the randomizer switch associated with the social media message is disabled, the central processor further configured to determine using the social media accounts database a social media account on which to post the social media content, wherein the central processor is further configured to post the social media posting on the social media account using the central processor network communication interface; and
wherein the central processor is further configured to delete the social media content from the social media content database after the social media posting posts on the social media account.

12. The system of claim 11, wherein the first network is the same as the second network.

13. The system of claim 11, wherein the first network is the Internet.

14. The system of claim 11, wherein the second network is the Internet.

15. The system of claim 11, wherein the first predetermined time interval is the same as the second predetermined time interval.

16. The system of claim 11, wherein the polling the social media content database at a first predetermined time interval is performed at the same time as polling the social media content database at a second predetermined time interval.

17. The system of claim 11, wherein the time-based selection criteria is a time range.

18. The system of claim 17, wherein the time-based selection criteria is a time range based upon the current time.

19. The system of claim 11, further comprising a local social media content database, wherein the local social media content database is stored on a portable computing device, wherein a social media message is stored in the local social media content database; and
the portable computing device comprises a portable computing device processor, the portable computing device processor configured to transmit the social media message from the local social media content database to the social media content database.

20. The system of claim 19, wherein the portable computing device stores the social media message in the local social media content database until the portable computing device is connected to a network and then transmits the social media message from the local social media content database to the social media content database.
